(19) United States
(12) Patent Application Publication
(10) Pub. No.: US 2024/0429721 A1
(43) Pub. Date: Dec. 26, 2024

(54) VOLTAGE CONTROLLED BATTERY CHARGER WITH SINGLE OUTPUT FOR MULTIPLE BATTERIES

(71) Applicant: DELTRAN OPERATIONS USA, INC., DELAND, FL (US)

(72) Inventors: PETER JAMES SHREAD, Deland, FL (US); FRANCISCO JAVIER DE LA CRUZ, Deland, FL (US)

(73) Assignee: DELTRAN OPERATIONS USA, INC., DELAND, FL (US)

(21) Appl. No.: 18/338,937

(22) Filed: Jun. 21, 2023

(51) Int. Cl. H02J 7/00

(52) U.S. Cl. CPC H02J 7/0013; H02J 7/0042

(57) ABSTRACT

A multiple bank battery charging system for charging two or more battery circuits simultaneously via voltage control only is disclosed. The multiple bank battery charging system does not monitor current of the charging current nor use current to control generation of the charging current. Instead, the multiple bank battery charging system only monitors voltage of the charging current generated by a controller. The multiple bank battery charging system may include a single output for sending the charging current to the multiple battery circuits for charging. As such, the multiple bank battery charging system is configured to charge multiple battery circuits simultaneously via a charging current discharged on a single outlet. The multiple bank battery charging system may also be configured to charge batteries having any battery chemistry.

### BACKGROUND

The invention relates to battery management systems, and more particularly, to battery charging systems configured with multiple battery circuits.

Conventional battery chargers charge batteries via charging profiles. Once a battery has been connected to a battery charger, the battery charger determines the state of charge of the battery and begins to charge the battery. At least some conventional battery chargers allow for different battery chemistries to be charged by the type of battery to be inputted into the battery charger. As such, the battery charger will use a previously stored charging algorithm associated with the chosen battery type. Most charging algorithms include a mode in which current is controlled, and also a mode in which voltage is controlled. To implement such charging algorithms requires complex systems to monitor and to control current and voltage, which makes the system expensive. Additionally, when a charging system is configured to charge multiple batteries, each battery charging bank for each battery includes all of the systems necessary to monitor and to control current and voltage. As such, a charging system capable of charging three batteries is formed from three banks, whereby each battery bank includes all of the systems necessary to monitor and to control current and voltage. Thus, a three bank battery charger includes three of each component necessary to monitor and to control current and voltage and to charge a single battery.

### SUMMARY OF THE INVENTION

A multiple bank battery charging system for charging two or more battery circuits simultaneously via voltage control only is disclosed. The multiple bank battery charging system does not monitor current of the charging current nor use current to control generation of the charging current. Instead, the multiple bank battery charging system only monitors voltage of the charging current generated by a controller. The multiple bank battery charging system may include a single output for sending the charging current to the multiple battery circuits for charging. As such, the multiple bank battery charging system is configured to charge multiple battery circuits simultaneously via a charging current discharged on a single outlet. The multiple bank battery charging system may also be configured to charge batteries having any battery chemistry.

In at least one embodiment, the multiple bank battery charger may include at least one controller with at least one power inlet configured to receive power from a power source. The multiple bank battery charger may include a first outlet configured to be coupled to at least one first battery circuit having a first nominal voltage and to be coupled to at least one second battery circuit having a second nominal voltage that is the same as the first nominal voltage of the at least one first battery circuit. Thus, both the first and second battery circuits have the same nominal voltage.

The multiple bank battery charger system may include one or more first voltage sensors in communication with the first battery circuit and one or more second voltage sensors in communication with the at least one second battery circuit. In at least one embodiment, the multiple bank battery charger system may include a controller configured to generate a charging current based on the monitored voltage. The controller may be configured to generate the charging current based only on voltage of the at least one first battery circuit and the at least one second battery circuit. As such, the controller does not control the generation of the charging current based on the current of the charging current. In at least one embodiment, the controller does not monitor the current.

The controller may be configured to generate a charging current based on the monitored voltages according to a charging profile for charging batteries in the at least one first battery circuit and the at least one second battery circuit. The charging current may be based on the monitored voltages according to a charging profile comprises a recovery mode, a voltage controlled, emulated constant current mode, a constant voltage mode and a maintenance mode.

In at least one embodiment in which the controller is in the recovery mode, the controller may adjust a regulated voltage of the charging current to be higher than the voltage of the first outlet configured to be coupled to at least one first battery circuit and to be coupled to at least one second battery circuit. When the controller is in the voltage controlled, emulated constant current mode, the controller may gradually increase the voltage of the first outlet configured to be coupled to at least one first battery circuit and to be coupled to at least one second battery circuit up to a Constant Current Mode battery voltage threshold. Once the Constant Current Mode battery voltage threshold has been reached, the controller then changes into the constant voltage mode. When the controller is in the constant voltage mode, the controller maintains voltage of the first outlet configured to be coupled to at least one first battery circuit and to be coupled to at least one second battery circuit at a maximum charging voltage. Once the controller determines that the battery circuits have reached full charge, the controller changes modes to the maintenance mode. When the controller is in the maintenance mode, the controller regulates voltage of the first outlet configured to be coupled to at least one first battery circuit and to be coupled to at least one second battery circuit at a maintenance voltage level.

In at least one embodiment, the controller may be configured to generate a charging current based on the monitored voltages for any battery chemistry. The controller may be configured to generate a charging current based on the monitored voltages for any battery chemistry such that the at least one first battery circuit has a first battery chemistry and the at least one second battery circuit has a second battery chemistry that differs from the first battery chemistry. In at least one embodiment, a lead acid chemistry type battery may have a bulk threshold of 14.6 volts. An absorbent glass mat (AGM) chemistry type battery may have a bulk threshold of 14.6 volts. A lithium chemistry type battery may have a bulk threshold of 14.5 volts. A bulk threshold of the chemistry independent charging thresholds and voltages for the system may be 14.5 volts. Lead Acid and AGM chemistry type batteries might not get charged up 100% in this scenario, but in such configuration, the system would not overcharge lithium batteries.

In at least one embodiment, the multiple bank battery charger system may include a controller with at least one power inlet configured to receive power from a power source. The controller may include a first outlet configured to be coupled to at least one first battery circuit having a first nominal voltage and to be coupled to at least one second battery circuit having a second nominal voltage that is the same as the first nominal voltage of the at least one first battery circuit. The multiple bank battery charger may include at least one voltage sensor in communication with the first outlet. The controller may be configured to generate a charging current based on the monitored voltage from the at least one voltage sensor to charge batteries in the at least one first battery circuit and the at least one second battery circuit. The controller may be configured to generate the charging current based entirely on voltage of the first outlet throughout a charging cycle, whereby the first outlet may be configured to be coupled to the at least one first battery circuit and the at least one second battery circuit. The first outlet may function as a single supply shared across all battery circuits coupled to the multiple bank battery charger.

In at least one embodiment, a method of charging multiple batteries may include receiving power from at least one power source and determining a voltage for at least one first battery circuit having a first nominal voltage and determining a voltage for at least one second battery circuit having a second nominal voltage that is the same as the first nominal voltage of the at least one first battery circuit. The method may include comparing the voltages of the at least one first and second battery circuits to identify a lower voltage. The method may include generating, via the at least one controller, a charging current based on the lower voltage from the at least one first battery circuit and the at least one second battery circuit, whereby the controller generates the charging current based only on voltage. The method step of generating, via the at least one controller, a charging current may include generating a charging current in a recovery mode, a voltage controlled, emulated constant current mode, a constant voltage mode and a maintenance mode.

An advantage of this system is that the multiple bank battery charger system only controls voltage which significantly reduces the complexity of the system and results in cost savings

Another advantage of this system is that the multiple bank battery charger system charges multiple batteries via a single output in electrical communication with each of the batteries.

Yet another advantage of this system is that the multiple bank battery charger system is configured to charge batteries having any battery chemistry.

These and other embodiments are described in more detail below.

### BRIEF DESCRIPTION OF THE FIGURES

FIG. 1 is a schematic diagram of the multiple bank battery charging system with two or more charging battery circuits, as indicated with battery 1, battery 2 and battery N.

FIG. 2 is a schematic diagram of the multiple bank battery charging system of FIG. 1 with two charging battery circuits.

FIG. 3 is a schematic diagram of the multiple bank battery charging system of FIG. 1 with at least four charging battery circuits.

FIG. 4 is a schematic diagram of the multiple bank battery charging system of FIG. 1 shown with only a single battery.

FIG. 5 is a graph of a charging profile usable from the multiple bank battery charging system of FIG. 1.

### DETAILED DESCRIPTION OF THE FIGURES

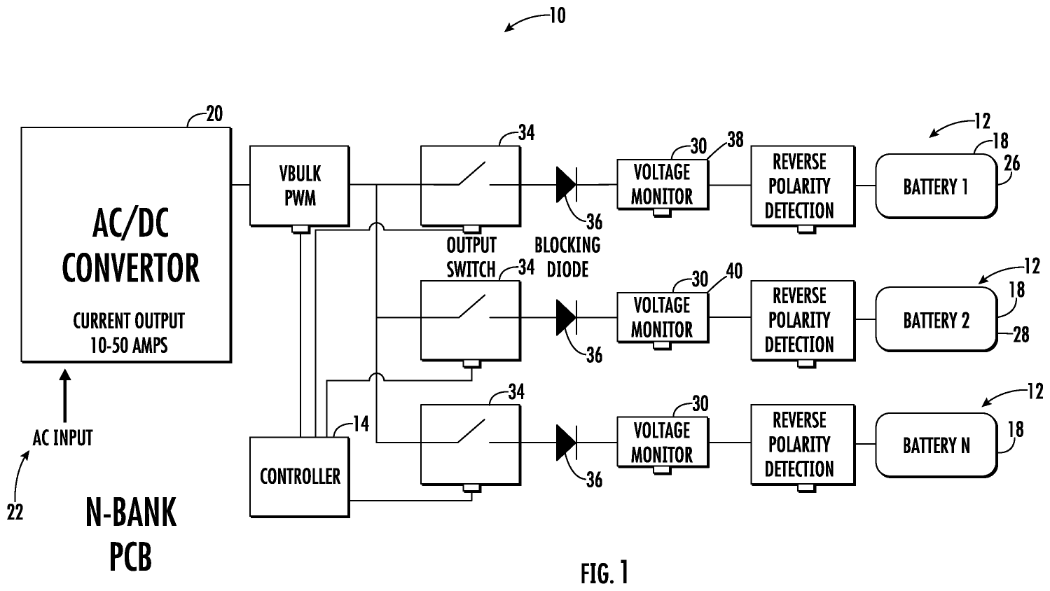

As shown in FIGS. 1-5, a multiple bank battery charging system 10 for charging two or more battery circuits 12 simultaneously via voltage control only is disclosed. The multiple bank battery charging system 10 does not monitor current of the charging current nor use current regulation to control generation of the charging current. Instead, the multiple bank battery charging system 10 only monitors voltage of the charging current generated by a controller 14. The multiple bank battery charging system 10 may include a single output 16 for sending the charging current to the multiple battery circuits 12 for charging. As such, the multiple bank battery charging system 10 is configured to charge multiple battery circuits 12 simultaneously via a charging current discharged on a single outlet 16. The multiple bank battery charging system 10 may also be configured to charge batteries 18 having any battery chemistry.

The multiple bank battery charging system 10 significantly reduces this cost and complexity by eliminating independent voltage and current regulation for multiple bank charging. The multiple bank battery charging system 10 uses a single supply outlet 16 that is shared across two or more batteries 18, which may be referred to as battery circuits 12 herein, thereby eliminating regulation per bank and elimination of current sending and end-of-line calibration, which significantly reduces costs and complexity. Furthermore, the multiple bank battery charging system 10 allows current to flow to a battery 12 having the least amount of charge in the battery 12 itself out of multiple batteries 12 connected to the multiple bank battery charging system 10 without complex interconnecting switches. For example, if the multiple bank battery charging system 10 has four batteries 12 coupled to the system 10 with one battery 12 being in a constant voltage mode of a charging profile and another battery 12 being in a highly discharged state, the charging current produced by the multiple bank battery charging system 10 and sent to the batteries 12 via the single outlet 16 will shift to that battery 12 that is in a highly discharged state.

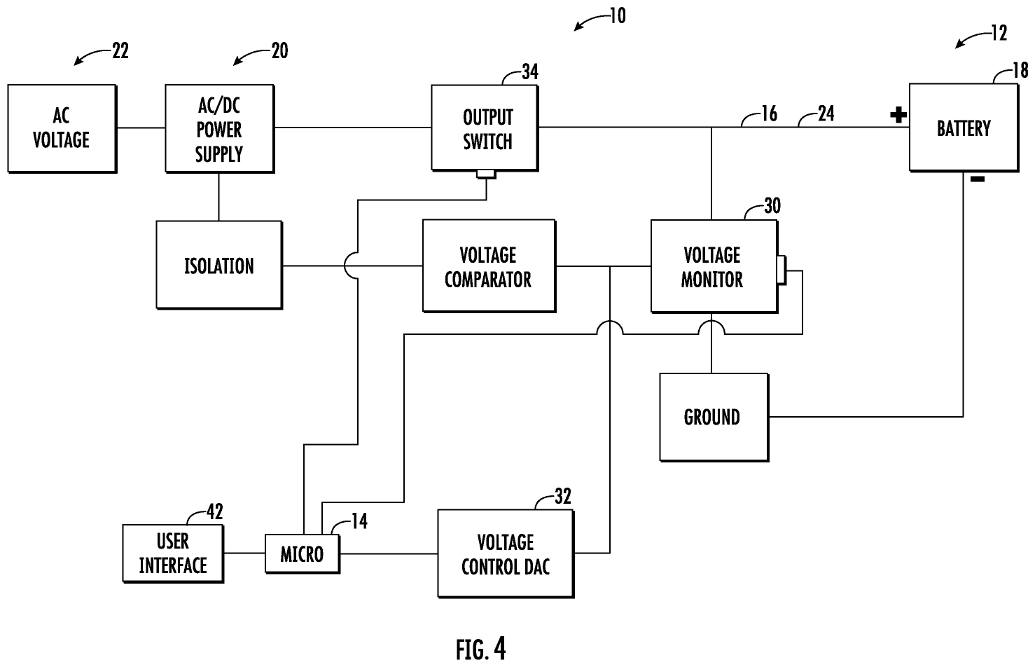

In at least one embodiment, as shown in FIG. 4, a multiple bank battery charging system 10 may include a controller 14 with at least one power inlet 20 configured to receive power from a power source 22. The controller 14 may include one or more first outlets 24 configured to be coupled to at least one first battery circuit 26 having a first nominal voltage and to be coupled to at least one second battery circuit 28 having a second nominal voltage that is the same as the first nominal voltage of the first battery circuit 26. The controller 14 may be any controller capable of controlling the multiple bank battery charging system 10. The controller 14 may or may not be programmable. The controller 14 may be coupled to a user interface 42 enabling a user to monitor the system 10. The user interface 42 may be any interface enabling communication between the controller 14 and one or more users. The user interface 42 may be, but is not limited to being, a graphical user interface, a computer, mobile device, such as, but not limited to, a mobile phone, a smartphone, a tablet, and a smartwatch.

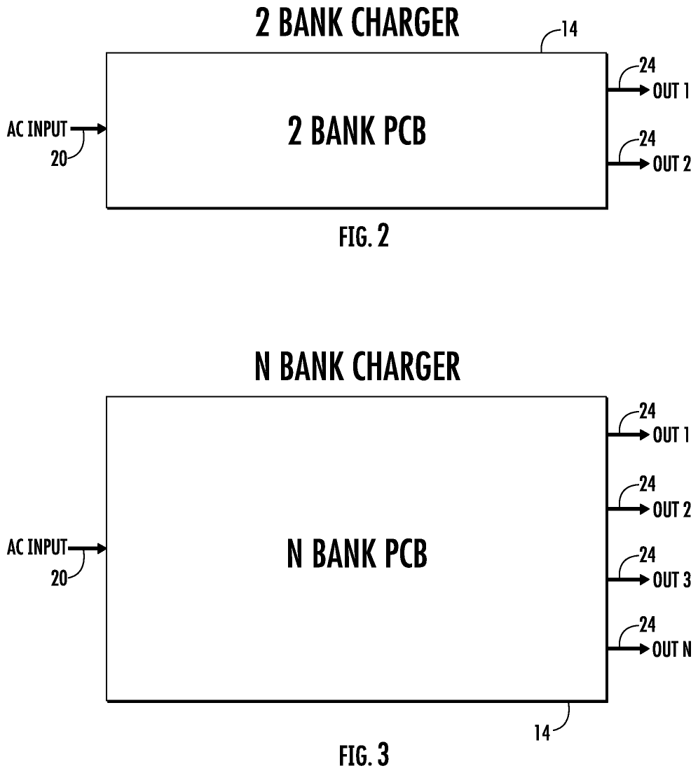

The multiple bank battery charging system 10 may include one or more voltage sensors 30 in communication with the first outlet 24. In at least one embodiment, as shown in FIG. 1, each battery circuit 12 may include a voltage sensor 30. In at least one embodiment, the multiple bank battery charging system 10 may include at least one first voltage sensor 38 in communication with the at least one first battery circuit 26. In at least one embodiment, the multiple bank battery charging system 10 may include at least one second voltage sensor 40 in communication with the at least one second battery circuit 28. The multiple bank battery charging system 10 may charge two or more battery circuits 12. As shown in FIGS. 2 and 3, the multiple bank battery charging system 10 may be configured to charge two battery circuits 12 simultaneously, four battery circuits 12 simultaneously and any other number of battery circuits 12 simultaneously.

One or more, or all, of the battery circuits 12 may also include one or more output switches 34 configured to isolate each battery 18 from other batteries coupled to the system 10 and from other components of the system 10. One or more, or all, of the battery circuits 12 may also include one or more blocking devices 36 to prevent a battery 18 from discharging back into other batteries 18 coupled to the system 10. One or more, or all, of the battery circuits 12 may also include a reverse polarity detection configured to provide an alert, such as, but not limited, to the controller 14, that a battery 18 has been improperly coupled to the system 10. Reverse polarity is independent for each charging circuit 12, and if a charging circuit 12 detects reverse polarity, that charging circuit's output switch 34 is opened and that charging bank goes into error mode.

In at least one embodiment, the controller 14 may be configured to generate a charging current based on the monitored voltage from at least the first and second voltage sensors 38, 40 to charge batteries in the first battery circuit 26 and the second battery circuit 28. The controller 14 may be configured to generate the charging current based only on voltage. In at least one embodiment, each battery charging circuit 12 will maintain a separate state or state of charge, or both. While the single outlet 16 is shared across all battery circuits 12, the charging state of each battery circuit 12 including at least one battery 18 is independent of the other battery circuits 12.

The controller 14 may be configured to generate a charging current based on the monitored voltages according to a charging profile for charging batteries in the first battery circuit 26 and the second battery circuit 28. In at least one embodiment, the charging profile may include a recovery mode, a voltage controlled, emulated constant current mode, a constant voltage mode or a maintenance mode, or all of these modes or any combination thereof. When power is initially applied to the controller via the power inlet 20 and the first outlet 24 has been coupled to the first and second battery circuits 26, 28, the controller 14 detects the battery circuits 26, 28 and may determine the voltage of first outlet 24 coupled to the first and second battery circuits 26, 28. The controller 14 may enter a recovery mode. If a charging circuit 12 transitions to recovery mode, any other charging circuits in recovery mode are reset to the start of recovery mode. The recovery mode state is maintained independently for each charging circuit 12. Charging may be suspended, and the output switches 34 opened for any other charging circuits 12 not in recovery mode.

When the controller 14 is in the recovery mode, the controller 14 may adjust a regulated voltage of the charging current generated by the controller 14 and emitted via the first outlet 24. The controller 14 may adjust the regulated voltage of the charging current to be slightly higher than the voltage of the first outlet 24 configured to be coupled to at least the first and second battery circuits 26, 28. Such operation of the controller 14 allows current to flow to one or more battery circuits 12 under a controlled voltage, thus limiting the charge rate. Such operation is leading the voltage. As the battery voltage increases at the first outlet 24 coupled to at least the first and second battery circuits 26, 28, the regulated voltage is kept slightly greater to continue current flow into the first and second battery circuits 26, 28.

In at least one embodiment, controller 14 may perform battery voltage level checks at intervals, such as, but not limited to two minutes and seven minutes from the start of charging. If the battery voltage is at or above voltage levels established for each interval, which, for example, but not by way of limitation, may be eight volts at a two minute interval and 10 volts at a seven minute interval, the charging continues. Otherwise an error code may be created, and the charging path is opened, thereby disconnecting a battery 18 from the charging circuit. This process is repeated each time a battery 18 is connected to a charging bank, regardless of the state of charge of any other battery 18 connected to the multiple bank battery charging system 10. Recovery mode timer checks are independent for each battery charging circuit 12 and if a charging bank times-out, that charging circuit's 12 output switch 34 is opened and that charging circuit goes into error mode.

Once the recovery mode has ended, the controller 14 of the multiple bank battery charger 10 moves into the voltage controlled, emulated constant current mode where the controller 14 gradually increases the voltage of the first outlet 24 configured to be coupled to at least one first battery circuit 26 and to be coupled to the at least one second battery circuit 28 up to a voltage controlled, emulated constant current mode battery voltage threshold. In at least one embodiment, each battery circuit 12 may be independently transitioned to voltage controlled, emulated constant current mode. The multiple bank battery charging system 10 does not directly regulate current. Instead, the multiple bank battery charging system 10 controls the voltage of the first outlet 24 to emulate current regulation. The charging battery circuit 12 may hold at the start of voltage controlled, emulated constant current mode if any charging circuits 12 are in recovery mode. Once there are no charging banks in recovery mode, the controller 14 ramps up output voltage to maximum output voltage for voltage controlled, emulated constant current mode and the voltage controlled, emulated constant current mode state is maintained independently for each battery charging circuit 12. Any charging circuit 12 that is suspended in voltage controlled, emulated constant current mode may resume voltage controlled, emulated constant current mode once the output voltage level is ramped up to the maximum output voltage for voltage controlled, emulated constant current mode. Voltage controlled, emulated constant current mode timer checks are independent for each charging circuit and if a charging circuit 12 times-out, that charging circuit's 12 output switch 34 may be opened and that charging circuit 12 goes into error mode.

Once the voltage of the first outlet 24 coupled to at least the first and second battery circuits 26, 28 is greater than the second level check in the recovery mode, the regulated voltage is slowly ramped up to the voltage controlled, emulated constant current mode battery voltage threshold, emulating a ramp up of current flow. Each battery circuit 12 may independently transition to constant voltage mode. Once the battery voltage, monitored through the voltage sensor 30 and voltage control circuit 32, reaches the voltage controlled, emulated constant current mode battery voltage threshold, the controller 14 transitions to constant voltage mode. This process is followed for each battery charging circuit 12. The battery charging circuit 12 with the lowest battery voltage drives the regulated voltage set point during current ramp up in the constant voltage mode. Any charging circuit 12 that is suspended in constant voltage mode may resume constant voltage mode once the output voltage level is ramped up to the maximum output voltage for voltage controlled, emulated constant current mode. Constant voltage mode timer checks are independent for each charging battery circuit 12 and if a charging battery circuit 12 times-out, that charging battery circuit's 12 output switch 34 may be opened and that charging battery circuit 12 may go into error mode.

When the controller 14 is in the constant voltage mode, the controller 14 may maintain voltage of the first outlet 24 configured to be coupled to at least one first battery circuit 26 and to be coupled to at least one second battery circuit 28 at a maximum charging voltage. Upon transition into the constant voltage mode, the multiple bank battery charging system 10 establishes regulated voltage of the charging current at the first outlet 24 to be a maximum charging voltage and maintains that voltage of the charging current.

In at least one embodiment in which the nominal voltage of the batteries in the battery circuits 12 is 12 volts. In other embodiments, the nominal voltage of the batteries in the battery circuits 12 is another voltage other than 12 volts. The controller 14 maintains the system 10 in the constant voltage mode according to the charging algorithm. Once this time period has expired, the controller 14 system transitions to maintenance mode, which then causes each battery circuit 12 to transition to maintenance mode.

Once the controller 14 transitions from constant voltage mode to maintenance mode, the controller 14 regulates voltage of the first outlet 24 configured to be coupled to at least one first battery circuit 26 and to be coupled to at least one second battery circuit 28 at a maintenance voltage level. Each battery circuit 12 may independently transition to maintenance mode. When the controller 14 is in maintenance mode, the multiple bank battery charging system 10 regulates the voltage of the first outlet 24 and all battery circuits 12 couple thereto at the maintenance voltage level. The controller 14 will stay in this mode indefinitely until all batteries 18 are disconnected or the battery's voltage drops below a restart threshold, and the controller 14 returns to constant current mode. Any charging battery circuit 12 that is suspended in maintenance mode will resume maintenance mode once the output voltage level is ramped up to the maximum output voltage for voltage controlled, emulated constant current mode.

In at least one embodiment, if a battery circuit 12 transitions into maintenance mode while other charging battery circuits 12 have not reached maintenance mode, a switch in line with the battery circuit 12 that transitioned into maintenance mode is opened to isolate that battery circuit 12. The controller 14 monitors the isolated battery circuit 12 and reconnects the battery circuit 12 to the first outlet 24 if the controller determines that the battery voltage of the isolated battery circuit 12 is below a maintenance voltage level. Once all the batteries 18 connected to the multiple bank battery charging system 10 reach maintenance mode, then the controller 14 regulates each battery circuit 12 to keep the batteries 12 in the battery circuits 12 at or above the maintenance voltage level. If a charging battery circuit 12 transitions to maintenance mode and no other charging battery circuits 12 are active, the output voltage of the charging current is set to output level for maintenance mode. If other charging battery circuits 12 are in recovery mode, voltage controlled, emulated constant current mode or constant voltage mode, the charging battery circuit's 12 output switch 34 may be opened and only closed momentarily if the charging battery circuit's 12 battery voltage drifts below the maintenance mode threshold and if the output voltage is set to the maximum output voltage for voltage controlled, emulated constant current mode. The system 10 may use hysteresis for opening and closing the output switch 34. Once all active charging battery circuits 12 transition to maintenance mode, the output voltage is set to the maintenance mode output level and all output switches 34 are closed.

In at least one embodiment, the controller 14 of the multiple bank battery charging system 10 is configured to generate a charging current based on the monitored voltages for any battery chemistry. In multi-chemistry, multi-bank chargers, the regulated voltages and thresholds are set per charging bank depending on the charging bank's selected chemistry. The multiple bank battery charging system 10 is configured to only regulate the voltage of the first outlet 24. Independent voltage control per battery chemistry is not possible. Instead, the multiple bank battery charging system 10 is configured to be an all-chemistry solution utilizing regulated voltages and thresholds that optimizes the charge for all chemistries while preventing overcharging conditions. For example, in at least one embodiment, the controller 14 may operate in the following manner:
Battery Detection Threshold: 2V;
Check One Level: 8V;
Check Two Level: 10V;
Constant Voltage Level: 14.6V;
Maintenance Voltage Level: 13.2 V; and
Restart Level: 12V.

Because the multiple bank battery charging system 10 does not control charging of each battery circuit 12 individually, there is no need for the system 10 to provide any chemistry selection of the battery type being charged. Each charging bank or battery circuit 12 is all-chemistry (e.g. Flooded Lead Acid, AGM, Lithium) battery circuit 12. The multiple bank battery charging system 10 may be capable of charging and maintaining any of the systems 10 without need for user chemistry selection. In at least one embodiment, the controller 14 may be configured to generate a charging current based on the monitored voltages for any battery chemistry such that the at least one first battery circuit 26 has a first battery chemistry and the at least one second battery circuit 28 has a second battery chemistry that differs from the first battery chemistry. In at least one embodiment, a lead acid chemistry type battery may have a bulk threshold of 14.6 volts. An absorbent glass mat (AGM) chemistry type battery may have a bulk threshold of 14.6 volts. A lithium chemistry type battery may have a bulk threshold of 14.5 volts. A bulk threshold of the chemistry independent charging thresholds and voltages for the system 10 may be 14.5 volts. Lead Acid and AGM chemistry type batteries might not get charged up 100% in this scenario, but in such configuration, the system 10 would not overcharge lithium batteries. These voltages and thresholds could be optimized, if desired.

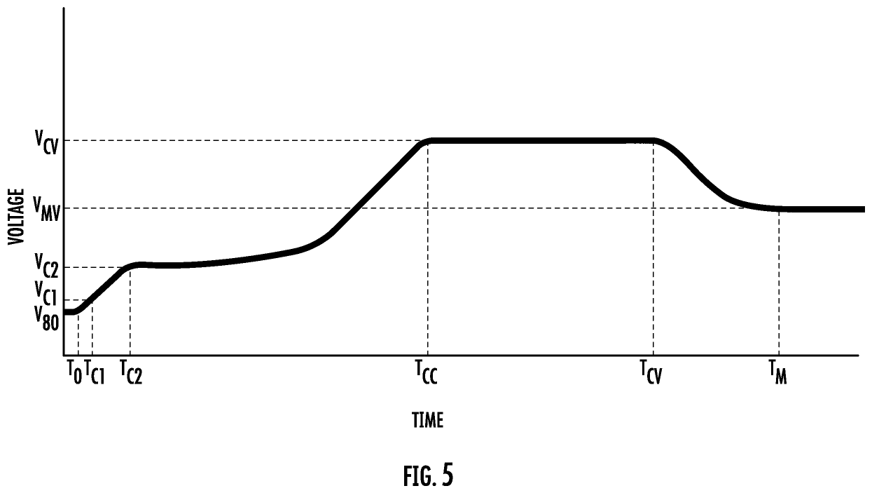

In at least one embodiment, the multiple bank battery charging system 10 may control battery charging via a charging profile, such as, but not limited to, a voltage control charging algorithm, as shown in FIG. 5. In at least one embodiment, the voltage and time for FIG. 5 may be as follows:

### Voltage

V BD: 2.00V, minimum battery voltage required to detect the battery
V_{C1}: 8.00V, battery voltage must reach this value within T_{C1} of charge start
V_{C2}: 10.00V, battery voltage must reach this value within T_{C2} of charge start
V_{CV}: 14.60V, Constant Voltage mode V_{MV}: 13.20V, Maintenance mode voltage

### Time

T₀: Start of charge cycle, 8 eight seconds after battery detect
T_{C1}: 2 minutes, battery voltage must reach V_{C1} within this period from T₀
T_{C2}: 7 minutes, battery voltage must reach V_{C2} within this period from T₀
T_{CC}: See table below, time in Voltage Controlled, Emulated Constant Current Mode until battery voltage >V_{CV}
T_{CV}: 8 hours max, time in Constant Voltage mode until battery voltage
T_{M}: Time in Maintenance Mode, indefinite

TABLE
Maximum Time in Voltage Controlled,
Emulated Constant Current Mode

| | | Constant Current |
|---|---|---|
| Max Current (A)>= | Max Current (A)< | Max Time T CC (H) |
| 0.00 | 1.25 | 80 |
| 1.25 | 4.00 | 33 |
| 4.00 | 6.00 | 25 |
| 6.00 | 10.00 | 20 |
| 10.00 | — | 15 |

In at least one embodiment, the multiple bank battery charger system 10 may include a controller 14 with at least one power inlet 20 configured to receive power from a power source 22 and including a first outlet 24 configured to be coupled to at least one first battery circuit 26 having a first nominal voltage and to be coupled to at least one second battery circuit 28 having a second nominal voltage that is the same as the first nominal voltage of the at least one first battery circuit 26. The multiple bank battery charger system 10 may include at least one voltage sensor 30 in communication with the first outlet 24. The controller 14 may be configured to generate a charging current based on the monitored voltage from the voltage sensor 30 to charge batteries in the at least one first battery circuit 26 and the at least one second battery circuit 28. The controller 14 may be configured to generate the charging current based entirely on voltage of the first outlet 24 throughout a charging cycle, whereby the first outlet 24 is configured to be coupled to the at least one first battery circuit 26 and the at least one second battery circuit 28. The first outlet may function as a single supply shared across all battery circuits 12 coupled to the multiple bank battery charger system 10.

In at least one embodiment, a multiple bank battery charger system 10 may include a controller 14 with at least one power inlet 20 configured to receive power from a power source 22 and comprising a first outlet 24 configured to be coupled to at least one first battery circuit 26 having a first nominal voltage and to be coupled to at least one second battery circuit 28 having a second nominal voltage that is the same as the first nominal voltage of the at least one first battery circuit 26. The multiple bank battery charger system 10 may include at least one voltage sensor 30 in communication with the first outlet 24. The controller 14 may be configured to generate a charging current based on the monitored voltage from the at least one voltage sensor 30 to charge batteries in the at least one first battery circuit 26 and the at least one second battery circuit 28. The controller 14 may be configured to generate the charging current based entirely on voltage of the first outlet 24 throughout a charging cycle, wherein the first outlet 24 is configured to be coupled to the at least one first battery circuit 26 and the at least one second battery circuit 28. The first outlet 24 may function as a single supply shared across all battery circuits 12 coupled to the multiple bank battery charger system 10. The charging current based on the monitored voltages according to the charging profile may include a charging profile including a recovery mode, a voltage controlled, emulated constant current mode, a constant voltage mode and a maintenance mode. The multiple bank battery charger system 10 may be configured such that when the controller 14 is in the voltage controlled, emulated constant current mode, the controller 14 gradually increases the voltage of the first outlet 24 configured to be coupled to at least one first battery circuit 26 and to be coupled to at least one second battery circuit 28 up to a voltage controlled, emulated constant current mode threshold. The multiple bank battery charger system 10 may be configured such that when the controller 14 is in the constant voltage mode, the controller 14 maintains voltage of the first outlet 24 configured to be coupled to at least one first battery circuit 26 and to be coupled to at least one second battery circuit 28 at a maximum charging voltage. The controller 14 may be configured to generate a charging current based on the monitored voltages for any battery chemistry.

A method of charging multiple batteries 18 via the multiple bank battery charger system 10 may include receiving power from at least one power source and determining a voltage for at least one first outlet 24 coupled to at least one first battery circuit 26 having a first nominal voltage and coupled to at least one second battery circuit 28 having a second nominal voltage that is the same as the first nominal voltage of the at least one first battery circuit, whereby the at least one first outlet 24 is in electrical communication with at least one controller 14. The method may also include generating, via the at least one controller 14, a charging current based on the voltage from the at least one first outlet 24 coupled to the at least one first battery circuit 26 and the at least one second battery circuit 28, whereby the controller 14 may generate the charging current based only on voltage of the first outlet 24 coupled to the at least one first battery circuit 26 and the at least one second battery circuit 28. The method of generating, via the at least one controller 14, a charging current may include generating a charging current in a recovery mode, a voltage controlled, emulated constant current mode, a constant voltage mode and a maintenance mode. The controller 14 may operate in each of these modes as previously set forth herein.

The foregoing is provided for purposes of illustrating, explaining, and describing embodiments of this invention. Modifications and adaptations to these embodiments will be apparent to those skilled in the art and may be made without departing from the scope or spirit of this invention.

I claim:

1. A multiple bank battery charger, comprising:
a controller with at least one power inlet configured to receive power from a power source and comprising a first outlet configured to be coupled to at least one first battery circuit having a first nominal voltage and to be coupled to at least one second battery circuit having a second nominal voltage that is the same as the first nominal voltage of the at least one first battery circuit;
at least one first voltage sensor in communication with the at least one first battery circuit;
at least one second voltage sensor in communication with the at least one second battery circuit;
wherein the controller is configured to generate a charging current based on the monitored voltage to charge batteries in the at least one first battery circuit and the at least one second battery circuit; and
wherein the controller is configured to generate the charging current based only on voltage.

2. The multiple bank battery charger of claim 1, wherein the controller is configured to generate a charging current based on the monitored voltages according to a charging profile for charging batteries in the at least one first battery circuit and the at least one second battery circuit.

3. The multiple bank battery charger of claim 2, wherein the charging current based on the monitored voltages according to a charging profile comprises a recovery mode, a voltage controlled, emulated constant current mode, a constant voltage mode and a maintenance mode.

4. The multiple bank battery charger of claim 3, wherein, when the controller is in the recovery mode, the controller adjusts a regulated voltage of the charging current to be higher than the voltage of the first outlet configured to be coupled to at least one first battery circuit and to be coupled to at least one second battery circuit.

5. The multiple bank battery charger of claim 3, wherein, when the controller is in the voltage controlled, emulated constant current mode, the controller gradually increases the voltage of the first outlet configured to be coupled to at least one first battery circuit and to be coupled to at least one second battery circuit up to a Constant Current Mode battery voltage threshold.

6. The multiple bank battery charger of claim 3, wherein, when the controller is in the constant voltage mode, the controller maintains voltage of the first outlet configured to be coupled to at least one first battery circuit and to be coupled to at least one second battery circuit at a maximum charging voltage.

7. The multiple bank battery charger of claim 3, wherein, when the controller is in the maintenance mode, the controller regulates voltage of the first outlet configured to be coupled to at least one first battery circuit and to be coupled to at least one second battery circuit at a maintenance voltage level.

8. The multiple bank battery charger of claim 1, wherein the controller is configured to generate a charging current based on the monitored voltages for any battery chemistry.

9. The multiple bank battery charger of claim 1, wherein the controller is configured to generate a charging current based on the monitored voltages for any battery chemistry such that the at least one first battery circuit has a first battery chemistry and the at least one second battery circuit has a second battery chemistry that differs from the first battery chemistry.

10. A multiple bank battery charger, comprising:
a controller with at least one power inlet configured to receive power from a power source and comprising a first outlet configured to be coupled to at least one first battery circuit having a first nominal voltage and to be coupled to at least one second battery circuit having a second nominal voltage that is the same as the first nominal voltage of the at least one first battery circuit;
at least one first voltage sensor in communication with the at least one first battery circuit and the first outlet;
at least one second voltage sensor in communication with the at least one second battery circuit and the first outlet;
wherein the controller is configured to generate a charging current based on the monitored voltage from the at least one first and second voltage sensors to charge batteries in the at least one first battery circuit and the at least one second battery circuit;
wherein the controller is configured to generate the charging current based entirely on monitored voltage throughout a charging cycle; and
wherein the first outlet functions as a single supply shared across all battery circuits coupled to the multiple bank battery charger.

11. The multiple bank battery charger of claim 1, wherein the controller is configured to generate a charging current based on the monitored voltages according to the charging profile for charging batteries in the at least one first battery circuit and the at least one second battery circuit.

12. The multiple bank battery charger of claim 2, wherein the charging current based on the monitored voltages according to the charging profile comprises a recovery mode, a voltage controlled, emulated constant current mode, a constant voltage mode and a maintenance mode.

13. The multiple bank battery charger of claim 3, wherein, when the controller is in the recovery mode, the controller adjusts a regulated voltage of the charging current to be higher than the voltage of the first outlet configured to be coupled to at least one first battery circuit and to be coupled to at least one second battery circuit.

14. The multiple bank battery charger of claim 3, wherein, when the controller is in the voltage controlled, emulated constant current mode, the controller gradually increases the voltage of the first outlet configured to be coupled to at least one first battery circuit and to be coupled to at least one second battery circuit up to a Constant Current Mode battery voltage threshold.

15. The multiple bank battery charger of claim 3, wherein, when the controller is in the constant voltage mode, the controller maintains voltage of the first outlet configured to be coupled to at least one first battery circuit and to be coupled to at least one second battery circuit at a maximum charging voltage.

16. The multiple bank battery charger of claim 3, wherein, when the controller is in the maintenance mode, the controller regulates voltage of the first outlet configured to be coupled to at least one first battery circuit and to be coupled to at least one second battery circuit at a maintenance voltage level.

17. The multiple bank battery charger of claim 1, wherein the controller is configured to generate a charging current based on the monitored voltages for any battery chemistry.

18. The multiple bank battery charger of claim 1, wherein the controller is configured to generate a charging current based on the monitored voltages for any battery chemistry such that the at least one first battery circuit has a first battery chemistry and the at least one second battery circuit has a second battery chemistry that differs from the first battery chemistry.

19. A method of charging multiple batteries, comprising:
receiving power from at least one power source;
determining a voltage for at least one first battery circuit having a first nominal voltage;
determining a voltage for at least one second battery circuit having a second nominal voltage that is the same as the first nominal voltage of the at least one first battery circuit;
comparing the voltages of the at least one first and second battery circuits to identify a lower voltage; and
generating, via the at least one controller, a charging current based on the lower voltage of the at least one first battery circuit or the at least one second battery circuit, wherein the controller generates the charging current based only on voltage.

20. The method of claim 19, wherein generating, via the at least one controller, a charging current comprises generating a charging current in a recovery mode, a voltage controlled, emulated constant current mode, a constant voltage mode and a maintenance mode.
